(19) United States
(12) Patent Application Publication
(10) Pub. No.: US 2007/0087086 A1
(43) Pub. Date: Apr. 19, 2007

(54) Method for producing potato products

(75) Inventors: Lisbeth Kalum, Vaerloese (DK); Poul Boerge Rosenius Poulsen, Bagsvaerd (DK)

Correspondence Address: NOVOZYMES NORTH AMERICA, INC., 500 FIFTH AVENUE, SUITE 1600, NEW YORK, NY, 10110, US

(73) Assignee: Novozymes A/S, Bagsvaerd (DK)

(21) Appl. No.: 10/580,808

(22) PCT Filed: Dec. 1, 2004
(86) PCT No.: PCT/DK04/00834

§ 371 Date: Jun. 10, 2006

(30) Foreign Application Priority Data
Dec. 2, 2003 (DK) PA 2003 01783

(51) Int. Cl. A23B 7/148

(52) U.S. Cl. 426/106

(57) ABSTRACT

The present invention relates to methods for producing vacuum packed pre-boiled potato products treated with a starch-degrading enzyme. The invention also relates to vacuum packed pre-boiled potato products obtained by the methods of the present invention.

### FIELD OF THE INVENTION

The present invention relates to methods for producing a vacuum packed pre-boiled potato product.

### BACKGROUND

Vacuum packed pre-boiled potato products are widely used by the food service sector, catering, institutions as well as by private households.

A conventional process for production for a vacuum packed pre-boiled potato product may comprise the steps of washing, peeling, cutting, packaging, boiling and cooling. The vacuum packed pre-boiled potato product may be stored refrigerated at approximately 4° C., for up to 5 weeks, or frozen for a longer period before use. When such a vacuum packed pre-boiled potato product is opened following storage the individual potatoes or potato pieces often have a tendency to stick together. It is an object of the present disclosure to provide improved methods for producing a vacuum packed pre-boiled potato product comprising potatoes or potato pieces having a reduced tendency to stick together when the package is opened following storage.

U.S. Pat. No. 4,058,631 discloses the pretreatment of raw, starchy food products with an aqueous solution of alpha-amylase to reduce the absorption of fats and oils during frying.

### SUMMARY OF THE INVENTION

The present invention relates to methods for producing a vacuum packed pre-boiled potato product from potatoes, comprising: removing the peel from the potatoes, contacting the potatoes with an aqueous solution comprising an effective amount of a starch-degrading enzyme, and vacuum packaging the enzyme-treated potatoes, wherein the enzyme-treated potatoes are boiled before or after vacuum packaging to produce a vacuum packed pre-boiled potato product.

The invention also relates to vacuum packed pre-boiled potato products obtained by the methods of the present invention.

Various references are cited herein, the disclosures of which are incorporated by reference in their entireties.

### DETAILED DESCRIPTION OF THE INVENTION

The vacuum packed pre-boiled potato product of the present invention may be any edible potato product, preferred are boiled whole potatoes or boiled potato pieces, e.g. potato slices or strips.

The potatoes are peeled using any appropriate method, e.g. such as steam peeling.

As described above the individual potatoes or potato pieces of such a vacuum packed pre-boiled potato product have a tendency to stick together when opened following storage. This effect may be due to particles of potato tissue from the process water being deposited on the surface of the potatoes or the potato pieces, and/or to protruding particles of potato tissue more closely bound to the potatoes or the potato pieces. Following boiling the starch particles glue the potatoes/potato pieces together. By adding a starch degrading enzyme to the process water the tendency of the individual potatoes or potato pieces to stick together can be reduced. Without being bound by theory it is proposed that the beneficial effect is due that the starch degrading enzyme reduces the amount of starch particles in the process water as well as “polish” the individual potatoes or the potato pieces for protruding starch particles. In addition the finish product, the vacuum packed pre-boiled potato product, when packaged in a transparent plastic material has a more appetizing appearance as the treatment gives a nice uniform yellowish colour as well as eliminates all visible starch particles between the individual potatoes/potato pieces.

In an embodiment the potatoes/potato pieces are further contacted with a pectinase.

In the methods of the present invention, the potato may by of any variety. Such varieties include, but are not limited to, Agata, Agria, Alex, Amadeus, Arno, Artana, Asparges, Asva, Atlantic, Balanse, Berber, Bintje, Burren, Calla, Carrera, Centennial Russet, Dali, Danva, Desiree, Ditta, Exempla, Exquisa, Fakse, Filea, Folva, Fontane, Godiva, Green Mountain, Hamlet, Hanna, Hansa, Hela, Imperia, Inova, Irish Cobbler “BC”, Jaerla Jutlandia, Kardal, Kardent, Karida, Karnico, Kennebec, Kenva, Keswick “NB 1”, King Edward, Kuras, Lady Rosetta, Laura, Liva, Marabel, Marion, Mercury, Milva Revelino, Minea, Nicola, Norchip, Norgold Russet “BC”, Norland, Octavia, Oleva, Panda, Posmo, Primula, Producent, Raja, Raja Bonanza, Red Pontiac, Red Warba, Revelino, Russet Burbank, Sava, Sebago, Secura, Senator, Seresta, Shepody, Sibu, Sieglinde, Sirtema, Stefano, Superior, Sydens Dronning, Symfonia, Tertus, Timate, Tivoli, Torva, Ukama, Victoria, Vivaldi, and White Rose.

The term “starch degrading enzyme” as used in the present invention is defined herein as an enzyme having starch degrading properties. Preferred starch degrading enzymes comprise alpha-amylases (EC 3.2.1.1), amyloglucosidases (EC 3.2.1.3) and maltogenic alpha-amylases (EC 3.2.1.133).

In the methods of the present invention, any alpha-amylase, amyloglucosidase, or maltogenic alpha-amylase may be used which possesses suitable enzyme activity in an appropriate pH and temperature range. It is preferable that the enzymes are active over broad pH and temperature ranges.

In a preferred embodiment, the enzymes have a pH optimum in the range of about 3 to about 10. In a more preferred embodiment, the enzyme(s) has a pH optimum in the range of about 4.5 to about 8.5.

In another preferred embodiment, the enzymes have a temperature optimum in the range of about 5° C. to about 100° C. In a more preferred embodiment, the enzymes have a temperature optimum in the range of about 25° C. to about 75° C.

In the methods of the present invention, the potato may be further treated with a pectinase during the enzyme-treatment step.

The term “effective amount” is defined herein as an amount of one or more enzymes that is sufficient for providing a measurable effect on at least one property of interest of the potato product.

The source of the enzymes is not critical for use in the methods of the present invention for improving one or more properties of a potato product. Accordingly, the enzymes may be obtained from any source such as a plant, microorganism, or animal. The enzymes are preferably obtained from a microbial source, such as a bacterium or a fungus, e.g., a filamentous fungus or yeast and may be obtained by techniques conventionally used in the art.

In a preferred embodiment, the enzymes are obtained from a bacterial source. For example, the enzymes may be obtained from an Acetobacter, Acinetobacter, Agrobacterium, Alcaligenes, Arthrobacter, Azotobacter, Bacillus, Comamonas, Clostridium, Gluconobacter, Halobacterium, Mycobacterium, Rhizobium, Salmonella, Serratia, Streptomyces, E. coli, Pseudomonas, Wolinella, or methylotrophic bacterium strain.

In a more preferred embodiment, the enzymes are obtained from an Acetobacter aceti, Alcaligenes faecalis, Arthrobacter oxidans, Azotobacter vinelandii, Bacillus alkalophilus, Bacillus amyloliquefaciens, Bacillus anitratum, Bacillus brevis, Bacillus circulans, Bacillus coagulans, Bacillus lautus, Bacillus lentus, Bacillus licheniformis, Bacillus megaterium, Bacillus stearothermophilus, Bacillus subtilis, Bacillus thuringiensis, Comamonas testosteroni, Clostridum tyrobutyricum, Gluconobacter dioxyaceticus, Gluconobacter lilquefaciens, Gluconobacter suboxydans, Halobacterium cutirubrum, Mycobacterium convolutum, Rhizobium melioti, Salmonella typhimurium, Serratia marcescens, Streptomyces lividans, Streptomyces murinus, Pseudomonas aeruginosa, Pseudomonas fluorescens, Pseudomonas putida, or Wolinella succinogens strain.

In another preferred embodiment, the enzymes are obtained from a fungal source. For example, the enzymes may be obtained from a yeast strain such as a Candida, Kluyveromyces, Pichia, Saccharomyces, Schizosaccharomyces, or Yarrowia strain; or from a filamentous fungal strain such as an Acremonium, Aspergillus, Aureobasidium, Chrysosporium, Cryptococcus, Filibasidium, Fusarium, Humicola, Magnaporthe, Monilia, Mucor, Myceliophthora, Neocallimastix, Neurospora, Paecilomyces, Penicillium, Phanerochaete, Piromyces, Schizophyllum, Sclerotium, Sporotrichum, Talaromyces, Thermoascus, Thielavia, Tolypocladium, or Trichoderma strain.

In another more preferred embodiment, the enzymes are obtained from an Aspergillus aculeatus, Aspergillus awamori, Aspergillus foetidus, Aspergillus japonicus, Aspergillus nidulans, Aspergillus niger, Aspergillus oryzae, Chrysosporium lignorum, Fusarium bactridioides, Fusarium cerealis, Fusarium crookwellense, Fusarium culmorum, Fusarium graminearum, Fusarium graminum, Fusarium heterosporum, Fusarium negundi, Fusarium oxysporum, Fusarium reticulatum, Fusarium roseum, Fusarium sambucinum, Fusarium sarcochroum, Fusarium sulphureum, Fusarium toruloseum, Fusarium trichothecioides, Fusarium venenatum, Humicola insolens, Humicola lanuginosa, Monilia sitophila, Mucor miehei, Myceliophthora thermophila, Neurospora crassa, Penicillium purpurogenum, Phanerochaete chrysporum, Polyporus pinsitus, Polyporus versicolour, Sclerotium rolfsii, Sporotrichum thermophile, Trichoderma citrinoviride, Trichoderma hamatum, Trichoderma harzianum, Trichoderma koningii, Trichoderma longibrachiatum, Trichoderma polysporum, Trichoderma reesei, Trichoderma saturnisporum, or Trichoderma viride strain.

The enzymes may be obtained from the organism in question by any suitable technique and in particular by use of recombinant DNA techniques known in the art (c.f. Sambrook, J. et al., 1989, Molecular Cloning, A Laboratory Manual, Cold Spring Harbor Press, Cold Spring Harbor, N.Y., USA). The use of recombinant DNA techniques generally comprises cultivation of a host cell transformed with a recombinant DNA vector, consisting of the product gene of interest inserted between an appropriate promoter and terminator, in a culture medium under conditions permitting the expression of the enzyme and recovering the enzyme from the culture. The DNA sequence may be of genomic, cDNA or synthetic origin or any mixture of these, and may be isolated or synthesized in accordance with methods known in the art. The enzyme may also be obtained from its naturally occurring source, such as a plant or organism, or relevant part thereof.

Preferred alpha-amylases are of fungal or bacterial origin. Contemplated alpha-amylase derived from a strain of Aspergillus includes Aspergillus oryzae and Aspergillus niger-amylases. Termamyl-like alpha-amylases, variant and hybrids thereof, are likewise contemplated according to the invention. Well-known Termamyl-like alpha-amylases include alpha-amylase derived from a strain of B. licheniformis, B. amyloliquefaciens, and B. stearothermophilus alpha-amylase (BSG). Other Termamyl-like alpha-amylases include alpha-amylase derived from a strain of the Bacillus sp. NCIB 12289, NCIB 12512, NCIB 12513 or DSM 9375, all of which are described in detail in WO 95/26397. In the context of the present invention a Termamyl-like alpha-amylase is an alpha-amylase as defined in WO 99/19467 on page 3, line 18 to page 6, line 27. Contemplated variants and hybrids are described in WO 96/23874, WO 97/41213, and WO 99/19467.

In the methods of the present invention, the enzymes may be obtained from commercial suppliers, preferably from Novozymes A/S. Commercially available amylases useful in the present invention are FUNGAMYL® (an Aspergillus oryzae alpha-amylase, available from Novozymes A/S, Denmark), BAN™ (a Bacillus licheniformis alpha-amylase, available from Novozymes A/S, Denmark), TERMAMYL® (a Bacillus alpha-amylase, available from Novozymes A/S, Denmark), and THERMOZYME™, a Bacillus alpha-amylase, available from Novozymes A/S, Denmark). Other useful commercially available amylase products include GRINDAMYL™ A 1000 or A 5000 (available from Danisco, Denmark) and AMYLASE H or AMYLASE P (available from DSM, The Netherlands). A commercially available amyloglucosidase is AMG™ (an Aspergillus niger amyloglucosidase, available from Novozymes A/S, Denmark). A commercially available maltogenic amylase is NOVAMYL™ (a Bacillus stearothermophilus maltogenic amylase, available from Novozymes A/S, Denmark). A commercially available pectinase useful in the present invention is PECTINEX™ Ultra (an Aspergillus niger pectinase, available from Novozymes A/S, Denmark).

In terms of enzyme activity, the appropriate dosage of a given enzyme will depend on the enzyme in question. The skilled person may determine a suitable enzyme unit dosage on the basis of methods known in the art.

The treatment of the potato with the one or more enzymes necessarily involves contacting the potato with the enzyme(s) under suitable conditions. Accordingly, the enzyme treatment may be performed by contacting the potato with the one or more enzymes in an aqueous preparation, e.g., an aqueous solution. The aqueous enzyme preparation may comprise a single enzyme component, e.g., a mono-component enzyme preparation, or a mixture of two or more of enzymes. The enzyme treatment can be performed by immersing the potato in such an aqueous preparation. Preferably the enzyme treatment is performed by adding the enzyme to the process water already applied during the process, e.g. to the rinse bath(s). The enzyme treatment of the potato is performed for a period of time sufficient to provide the desired property to the potato product. The potato is preferably treated for a period of time of at least 1 minute, more preferably at least 2 minutes, even more preferably at least 5 minutes, and most preferably at least 10 minutes.

Thus, the enzymes to be used in the methods of the present invention may be in any form suitable for the use in question, e.g., in the form of a dry powder, agglomerated powder, or granulate, in particular a non-dusting granulate, a liquid, in particular a stabilized liquid, or a protected enzyme.

In the methods of the present invention, the effective amount of the alpha-amylase, e.g. Fungamyl 800L, is about 1 g to about 1000 g enzyme protein per 1000 litre process water, more preferably about 10 g to about 500 g per 1000 litre process water, even more preferably about 50 g to about 250 g per 1000 litre process water, and most preferably about 70 g to about 125 g per 1000 litre process water.

An alpha-amylase, such as Fungamyl 800L is applied in the amount of preferably 8 to 80000 KNU per 1000 litre process water, more preferably 80 to 8000 KNU per 1000 litre process water, and most preferably 400 to 2000 KNU per 1000 litre process water, such as around 800 KNU per litre process water.

Depending on the stability of the starch degrading enzyme and the substrate load the enzyme in the process water may remain active in effective amounts for 1 hr or up to several days.

The methods of the present invention may further comprise the step of blanching the potato. Preferably, blanching is performed prior to enzyme treatment. The blanching may be performed in accordance with procedures well-known in the art (see, for example, U.S. Pat. No. 4,254,153 and Andersson et al., 1994, Critical Reviews in Food Science and Nutrition 34:229-251). The blanching may, for example, be performed by heating the potato in an aqueous solution, such as pure water, preferably in the temperature range of about 70° C. to about 100° C. for about 2 to about 15 minutes, more preferably in the temperature range of about 75° C. to about 90° C. for about 4 to about 10 minutes, and most preferably at about 75° C. for about 10 minutes. Alternatively, the potato may be blanched in steam, such as at atmospheric pressure for about 2 to about 10 minutes.

It is understood that any of the embodiments described herein may be combined to produce a potato product.

The invention also relates to potato products obtained by the methods of the present invention.

The present invention is further described by the following examples that should not be construed as limiting the scope of the invention.

Materials and Methods

The enzyme preparations used were commercial amylases: Termamyl SC (120 KNU/ml), BAN 240L (240 KNU/ml), and Fungamyl 800L (800 FAU/ml) all available from Novozymes A/S.

Dry (DS) was determined by incubation at 105° C. until constant weight.

The amount of soluble starch was detected using an iodine test. An iodine solution is prepared by dissolving 1 g iodine and 10 g potassium iodide in 1 litre of water. Approximately 10 ml sample is placed in a test tube and 1 ml iodine solution is gently added. The amount of soluble starch is determined using a semi-quantitative test where 3 indicates a high amount of starch (dark blue or black colour), 2 indicates a medium amount of starch (brownish or reddish brown), and 1 indicates no starch (pale yellow).

### EXAMPLE 1

### Enzyme Treatment of Potato Process Water

Industrial process water from a potato processing line producing consumable potato products was treated. The process water was hazy; having 1% dry DS, BRIX 0.9, pH 4.7 and a temperature during production of 35° C. The process water was incubated with the commercial amylase preparations for 20 minutes, 1 hour and 20 hours at 35° C. (water bath, no stirring) using a dose range (in v/v %) of 0, 0.1, 0.5, 1 and 5%. The amount of soluble starch after end incubation time was determined using the iodine test. The results are given in table 1.

TABLE 1
Amount of soluble starch in industrial process water after
incubation with amylases.

| | Ban 240 L | | | Fungamyl 800 L | | | Termamyl SC | | |
|---|---|---|---|---|---|---|---|---|---|
| Dose | 20 | 1 | 20 | 20 | 1 | 20 | 20 | 1 | 20 |
| (v/v) % | min | hour | hours | min | hour | hours | min | hour | hours |
| 0 | 3 | 3 | 3 | 3 | 3 | 3 | 3 | 3 | 3 |
| 0.1 | 3 | 3 | 3 | 3 | 2.5 | 1 | 3 | 3 | 1 |
| 0.5 | 3 | 2.5 | 2.5 | 2.5 | 1.5 | 1 | 3 | 3 | 1 |
| 1 | 3 | 2 | 2.5 | 1.5 | 1.5 | 1 | 3 | 2 | 1 |
| 5 | 3 | 2 | 2.5 | 1.5 | 1.5 | 1 | 3 | 2 | 1 |

All three enzymes reduced the level of soluble starch. Termamyl SC and Fungamyl 800 L hydrolyzed all soluble starch after 20 hours.

### EXAMPLE 2

Fungamyl 800L was tested in industrial scale in a process comprising first rinse bath, steam peeling, brushing, second rinse bath, third rinse bath, packaging, and boiling. Potatoes (c.v. Sava, size 40/45, 20.3% DS) were processed at a rate of 3500 kg/hour. The potato tubers were rinsed for dirt in a first rinse bath. The skin was removed by steam treatment and subsequent brushing. Fungamyl 800L was used in an amount of 1 L enzyme per 1000 L process water, i.e. to the second rinse bath (1000 L, pH 4-4.5, 35° C.) and the third rinse bath (500 L, pH 5.5, 43° C.). The residence time of the potatoes in the second rinse bath was from 5 to 10 minutes and in the third rinse bath was 1 to 3 minutes. The potato tubers were vacuum-packed and boiled in the package for about 70 minutes at 95° C. before being cooled down and subsequently stored at 4° C. until analysis. Reference samples were drawn before the enzyme was added in the process line, and the enzyme treated samples were drawn one hour after enzyme addition.

The level of soluble starch was followed for two hours in the second rinse bath and in the third rinse bath during production. Results are shown in table 2.

TABLE 2
Amount of soluble starch in the second rinse bath and the third rinse
bath after incubation with alpha-amylase. The enzyme was added
at 0 minutes.

| Time (minutes) | Second rinse bath | Third rinse bath |
|---|---|---|
| Start (0 min) | 3 | 2 |
| 10 min | 1 | 1 |
| 20 min | 1 | 1 |
| 30 min | 1 | 1 |
| 60 min | 1 | 1 |
| 90 min | 1 | 1 |
| 120 min | 1 | 1 |

All soluble starch was hydrolyzed 10 minutes after addition of Fungamyl. The effect. of Fungamyl 800L was maintained during the 2 hours of the trial.

The degree of clotting was determined after 1 and 7 days of storage. A 3 kg pre-boiled, vacuum packed potato package stored for 1 or 7 days at 4° C. was opened and the content poured out. The number of potato pieces sticking together when lifted was registered. The degree of clotting is given as the total number of potatoes in a package sticking together.

The results are listed in table 3.

TABLE 3
Degree of clotting of boiled, vacuum-packed potatoes upon storage
at 4° C.

| | After 1 day | After 7 days |
|---|---|---|
| Reference (no enzyme) | 11 | 32 |
| Fungamyl 800 L | 5 | 0 |

The number of potatoes sticking together was significantly reduced when Fungamyl 800 L was added to the process water.

The invention described and claimed herein is not to be limited in scope by the specific embodiments herein disclosed, since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims.

1-5. (canceled)

6. A method for producing a vacuum packed pre-boiled potato product, comprising:
a. removing the peel from the potatoes,
b. contacting the potatoes with an effective amount of a starch-degrading enzyme, and
c. vacuum packaging the enzyme-treated potatoes
wherein the enzyme-treated potatoes are boiled before or after step (c) to produce a vacuum packed pre-boiled potato product.

7. The method of claim 6, wherein the starch degrading enzyme is an alpha-amylase.

8. The method of claim 6, wherein the alpha-amylase is derived from Aspergillus sp.

9. The method of claim 6, wherein the alpha-amylase is derived from Aspergillus oryzae or Aspergillus niger.

10. The method of claim 6, wherein the alpha-amylase is derived from Bacillus sp.

11. The method of claim 6, wherein the alpha-amylase is derived from Bacillus licheniformis.

12. The method of claim 6, further comprising cutting the peeled potatoes into pieces.

13. The method of claim 6, wherein the starch-degrading enzyme is in an aqueous composition.

14. A vacuum packed pre-boiled potato product prepared by the method of claim 6.
